(19) United States
(12) Patent Application Publication
(10) Pub. No.: US 2007/0126795 A1
(43) Pub. Date: Jun. 7, 2007

(54) MODULAR MATERIAL PROCESSING SYSTEM AND SAFETY INTERLOCK SCHEME AND METHOD OF OPERATION

(75) Inventors: Steven G. DORFE, Maple Grove, MN (US); Richard A. HOKANSON, Minneapolis, MN (US)

Correspondence Address: HAMRE, SCHUMANN, MUELLER & LARSON, P.C., P.O. BOX 2902, MINNEAPOLIS, MN, 55402-0902, US

(73) Assignee: DATACARD CORPORATION, Minnetonka, MN (US)

(21) Appl. No.: 11/557,660

(22) Filed: Nov. 8, 2006

Related U.S. Application Data
(60) Provisional application No. 60/739,764, filed on Nov. 23, 2005.

(51) Int. Cl. B41J 2/14; B41J 2/16

(52) U.S. Cl. 347/49

(57) ABSTRACT

A modular card production safety interlock system limits disruption of a modular card production system by limiting operational disturbances to a desired system module and only its neighboring system modules upon opening the hood of the desired system module.

### BACKGROUND OF THE INVENTION

1. Cross-Reference to Related Applications

The present application claims the benefit of U.S. Provisional Patent Application Ser. No. 60/739,764 entitled “MODULAR MATERIAL PROCESSING SYSTEM SAFETY INTERLOCK SCHEME AND METHOD OF OPERATION,” filed on Nov. 23, 2005, which is herewith incorporated by reference in its entirety.

2. Field of the Invention

This invention relates generally to the field of modular material processing systems. More particularly, the invention relates to a modular material processing system safety interlock scheme that limits disruption of a modular material processing system by limiting operational disturbances to a desired system processing (function) module and only its neighboring system modules upon opening the hood of the desired system module.

3. Description of the Prior Art

Modular material processing systems are used to produce large volumes of a variety of different types of personalized identity documents including, but not limited to, credit cards, licenses, personal identification cards, calling cards, and booklets such as passports, among other types of documents. Generally, these systems include a number of different modules that perform various functions. These functions can include but are not confined to magnetic encoding, embossing, smart card programming, laser printing, cleaning, and laminating of personalized documents. Examples of modular material processing systems are numerous.

In a system with multiple modules, where each module has its own hood, it is typical that if one hood is opened, it will affect the operation of the other modules throughout the modular material processing system.

Although modular material processing systems are becoming more technologically advanced, a need still exists for a modular material processing system safety interlock scheme that limits disruption of a modular material processing system by limiting operational disturbances to a desired system module and only its neighboring system modules upon opening the hood of the desired system module.

### SUMMARY OF THE INVENTION

The present invention is directed to a modular material processing system safety interlock scheme that limits disruption of a modular material processing system by limiting operational disturbances to a desired system module and only its neighboring system modules upon opening the hood of the desired system module.

The material processing system most preferably includes a plurality of function modules and a DC voltage supply bus that allows peer-topeer interlock control solely between adjacent function modules within the material processing system.

According to one embodiment, a modular material processing system comprises a plurality of sequentially ordered modules, wherein each module is coupled to an adjacent upstream and/or downstream module. This system may also comprise a main or primary controller in electrical communication with each of the modules. Those skilled in the art will readily appreciate the controller could be any suitable control unit such as, but not limited to, a CPU, personal computer, microprocessor, microcomputer, microcontroller, and many other types of data processing control units. Each system module is protected via an enclosed hood (cover) to prevent accidental access to the material(s), e.g. cards, being processed via the module. Upon opening the hood associated with a desired system module, and without assistance from the main controller, the desired system module controls via the safety interlock system, operation of its adjacent system modules. Modules that are not adjacent to the desired module are unaffected by the hood opening, and continue to process material(s) elsewhere in the modular material processing system. Localizing the disruption allows the modular material processing system to minimize material scrap when a hood is opened for inspection, maintenance, upgrading, and the like.

Accordingly, one feature of the invention is directed to providing a modular material processing system that operates in accordance with safety requirements specified, for example, by predetermined organizations, e.g., UL or TUV. When a module hood is opened, for example, it is most preferable to also disrupt power to adjacent modules such that accidental mechanical or electrical injuries originating from an adjacent module can be prevented during maintenance operations associated with the module being serviced.

Another feature of the invention is directed to providing a modular material processing system that operates to localize module operational disruptions resulting in reduced material scrap whenever a module hood is opened to provide manual access.

Yet another feature of the invention is directed to providing a modular material processing system that operates to discourage a system operator from manually adjusting material handled by the system during a disrupted operational state. This feature importantly prevents inaccurate material creation or material tracking errors due to manual adjustments of materials being processed elsewhere in the system during disruption of one or more modules in a different system location.

### BRIEF DESCRIPTION OF THE DRAWINGS

Other aspects and features of the present invention and many of the attendant advantages of the present invention will be readily appreciated as the same becomes better understood by reference to the following detailed description when considered in connection with the accompanying drawings in which like reference numerals designate like parts throughout the figures thereof and wherein:

FIG. 1 is a schematic diagram illustrating a modular material processing system safety interlock scheme according to one embodiment of the present invention; and

FIG. 2 is a perspective view illustrating a modular material processing system.

While the above-identified drawing figures set forth alternative embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

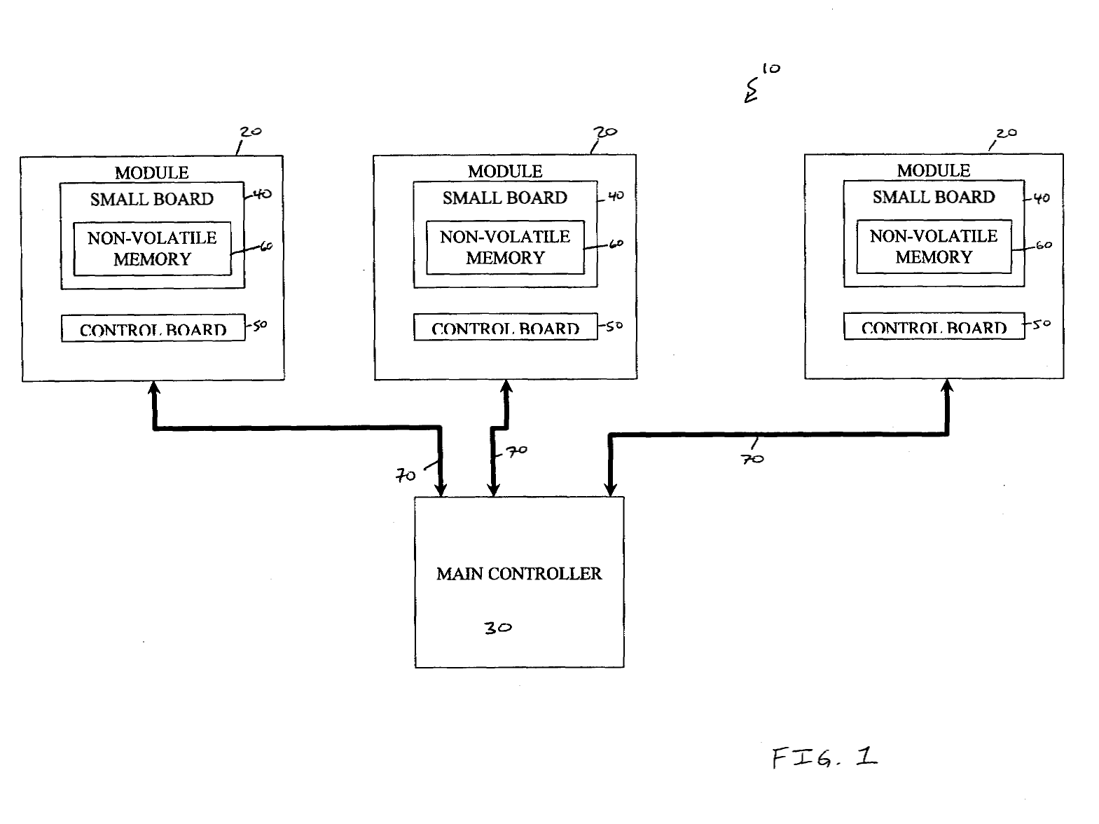

Looking now at FIG. 1, a schematic diagram illustrates a modular material processing system 10 including a safety interlock system 12 according to one embodiment. Material processing system 10 has a first material processing module 14, a down-stream module 16, and an up-stream module 18. The safety interlock system 12 can be seen to have a generic architecture suitable for use with each system module 14, 16, 18. The generic safety interlock system 12 associated with each module obtains its power from a +12VDC power transmission device associated solely with its respective module. Exemplary power transmission devices may include, but are not limited to, lasers and laser devices, hazardous light devices, pneumatic devices, hydraulic devices, voltage controller devices, current controller devices and ultraviolet light devices.

This architecture advantageously eliminates the necessity for providing a common power source that must be configured to supply power to all of the modules in the material processing system 10.

Another advantage provided with such an architecture is the provision of enhanced isolation between the system modules, thus enhancing also the system modularity. Historically, such systems have used a common DC power source to enable all of the module interlocks within the system 10. Such common DC power sources have been difficult to scale in terms of architecture and available interlock power, especially when applied to large, modular material processing systems.

Operation of the safety interlock system 12 will be described now below with reference to a single module 14 in order to enhance the clarity in describing features of the safety interlock system 12. It shall be understood however, that each module 14, 16, 18 operates in the same fashion.

Looking now at module 14, a 12VDC power transmission device 20 is provided on a module interlock board 22. A power transmission device voltage 20 passes through an interlock switch 24 that is configured to open when the module 14 hood is opened, and that is configured to close when the module 14 hood is closed. As illustrated in FIG. 1, interlock switch 24 is interpreted to also represent the module 14 hood. When interlock switch 24 is in its closed position, a 12VDC voltage will connect via a DC bus 26 to interconnect pin 3 of modules 14 and 18, and loop back to interconnect pin 2 of modules 18 and 14 via a loop back switch 28 in module 18. Loop back switch 28 is energized solely via the 12VDC power transmission device 42 associated with module 18. So long as the hood of module 18 is closed, interlock switch 30 will be closed to supply the requisite power to maintain closure of interlock switch 30 and loop back switch 28. In like fashion, so long as the hood of module 14 is closed, interlock switch 24 will be closed to supply the requisite power to maintain closure of interlock switch 24 and loop back switch 32. Closure of loop back switches 28 and 32 will result in 12VDC appearing at interlock terminals 34 and 36 via interlock switches 38 and 40 respectively, to supply power to various module components such as motor circuits related to the material processing operations associated solely with modules 14 and 16.

The modular material processing system 10 architecture importantly eliminates the use of a single primary power source to provide power to the modules in the system 10. This feature allows the system 10 to grow or shrink to any desired size, since the use of individual module power sources eliminates the necessity to scale and rescale the size of the primary power source to meet the changing needs of the system 10 as the size of the system 10 changes.

This system 10 architecture also provides the requisite safety features necessary to meet or exceed regulatory requirements set by agencies such as Underwriters Laboratories (UL) and TUV. Opening the hood of one module, for example, will disable the motor drive circuits associated with the module as well as the motor drive circuits associated with any adjacent modules. In this way, an operator can manually interrogate the module having the open hood without concern for mechanical or electrical related injuries resulting from nearby modules.

This system 10 architecture further advantageously substantially eliminates or minimizes the production of scrap associated with the material processing operation. Since, as stated herein before, opening the hood of a single module affects only the operation of the single module and any adjacent modules, the remaining modules in the system 10 continue to operate and process any materials passing through those remaining modules. In this way, materials being processed elsewhere in the system 10 are not wasted, and the efficiency of the material processing operation is optimized for maximum throughput. This feature becomes even more important as the size of the system 10 increases with respect to the number of modules in the system 10. This features becomes more important also as the cost associated with the materials being processed by the system 10 increases.

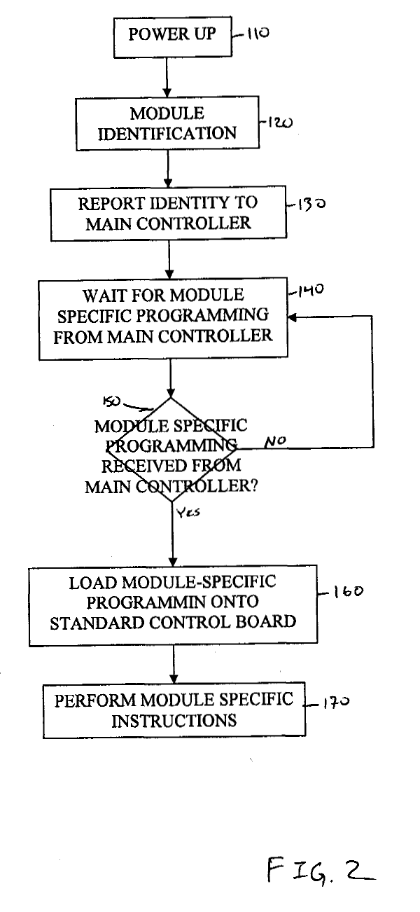

FIG. 2 depicts a perspective view of a modular material processing system 100. Material processing system 100 can be seen to include a plurality of processing (function) modules 14 that are configured in a sequential arrangement to process material such as identification cards discussed herein before. Material processing system 100 can also be seen to include an operator station 120, an input hopper 130, and an output hopper 150. A system controller 122, illustrated in dashed lines in FIG. 2, resides in the housing 127. The controller 122 controls operation of the system 100 and transfers data to and from the input hopper 130, the modules 14, and the output hopper 150. The controller 122 can be a computer or any central processing unit suitable for transferring data and processing information, as stated herein before. Operator interface means 123, 123a are connected to a data port system 123b of the controller 122 to permit control commands and data input to the controller 122. Preferably, the interface means 123, 123a are a keyboard and mouse, as depicted in FIG. 2. However, it will be appreciated that other suitable interface means may be employed. Each module 14 also includes its own module controller (not shown) that controls the functions and operation of the respective module.

The input hopper 130 preferably includes at least one tray 137 configured to hold a supply of cards 137a. The input hopper 130 works by picking a card 137a from the supply tray 137 and transferring the card into the adjacent downstream processing module 14 to begin the card (material) processing. A cover 131 protects the inside of the input hopper 130.

As with the input hopper 130, each function module 14 includes a cover 141. The covers 141 may include a transparent surface allowing a user or operator to view the inside of each of the processing modules 14. A variety of processing modules 14 may be employed in the system 100, including, but not limited to 1) a magnetic stripe module for writing data to and reading data from a magnetic stripe on the cards, 2) an embossing module for forming embossed characters on the cards, 3) a smart card programming module for programming an integrated circuit chip on the cards, 4) a printer module for performing monochromatic or multi-color printing, 5) a laser module for performing laser personalization on the cards, 6) a graphics module for applying monochromatic data and images to the cards, 7) a cleaning module for cleaning the cards, 8) a topping module for applying a topcoat to the cards, and 9) a card punching module to punch or cut a hole into the cards and/or to punch the card into a specific shape.

In summary explanation, a modular material processing system includes a plurality of function modules, wherein each module has an access cover, a plurality of interlock switches, and a power transmission device integrated therein. The interlock switches are configured together as a safety interlock system such that opening a single module access cover operates to disable the respective module power transmission device and deactivate hazard related circuits associated with the respective module and solely any adjacent modules.

The invention may be embodied in other forms without departing from the spirit or essential characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

The modular material processing system 10, for example, may also employ a bypass sense feature 50 that is configured to allow under certain predetermined operating conditions, continued processing of material(s), even when a module hood is opened. Further, each function module may be accessed manually via a door, covering, shield, or other type of entry mechanism rather than via a hood as discussed herein before. It shall also be understood that although various switches are depicted as coil activated devices, the present invention is not so limited; and solid state devices, among other types of switching devices, could just as easily be employed to achieve the desired results according to the principles described herein before.

What is claimed is:

1. An interlock system, comprising:
a protective cover associated with a material processing function module;
a power transmission device integral solely with the function module; and
a safety interlock circuit, wherein opening the protective cover disables the power transmission device to activate the safety interlock circuit causing the function module and solely adjacent function modules to stop processing material passing through the respective function modules.

2. The interlock system according to claim 1, wherein the safety interlock circuit comprises:
a module interlock circuit responsive to action of the protective cover;
an adjacent upstream module interlock circuit coupled to the module interlock circuit, wherein an adjacent upstream module protective cover must be closed such that the module interlock circuit will allow hazardous elements to be active within the module; and
a downstream module interlock circuit coupled to the module interlock circuit, wherein an adjacent downstream module protective cover must be closed such that the module interlock circuit will allow hazardous elements to be active within the module.

3. The interlock system according to claim 2, wherein all module interlock circuits are substantially identical, allowing modules to be connected in arbitrary order.

4. The interlock system according to claim 3, wherein the module interlock circuit coupling to adjacent modules is via electromechanical switches.

5. The interlock system according to claim 1, wherein the function module is selected from the group consisting of a magnetic encoding module, an embossing module, a smart card module, a chip programming module, a laser printing module, a perforating module, a cleaning module, a laminating of personalized documents module, a thermal module, an inkjet module, a retransfer printing module, an input module, an output module, a label module, a topper module, a buffer module, a booklet leafing module, and a booklet closing module.

6. An interlock system, comprising:
accessing means for controlling manual access into a material processing function module;
means for supplying power solely to the function module and at least one adjacent module; and
interlocking means for disabling the means for supplying power and causing the function module and solely any adjacent function modules to stop processing material passing through the respective function modules in response to the manual access into the function module via the accessing means.

7. The interlock system according to claim 6, wherein the accessing means comprises a module access cover.

8. The interlock system according to claim 6, wherein the means for supplying power comprises a motor driver circuit.

9. The interlock system according to claim 6, wherein the interlocking means comprises a plurality of interlock switches configured together to disable power to motor circuits associated with the function module and solely adjacent function modules in response to the manual access into the function module via the accessing means.

10. The interlock system according to claim 7, wherein the material processing function modules are selected from the group consisting of a magnetic encoding module, an embossing module, a smart card module, a chip programming module, a laser printing module, a perforating module, a cleaning module, a laminating of personalized documents module, a thermal module, an inkjet module, a retransfer printing module, an input module, an output module, a label module, a topper module, a buffer module, a booklet leafing module, and a booklet closing module.

11. A method of interlocking a plurality of modular material processing system function modules, the method comprising the steps of:
providing a modular material processing system having a plurality of function modules, wherein each module has an access cover, a plurality of interlock switches, and a power transmission device integrated therein; and
configuring the plurality of function modules such that opening a single module access cover operates to disable the respective module power transmission device and deactivate hazard related circuits associated with the respective module and solely any adjacent modules.

12. The method according to claim 11, wherein the function modules are selected from the group consisting of a magnetic encoding module, an embossing module, a smart card module, a chip programming module, a laser printing module, a perforating module, a cleaning module, a laminating of personalized documents module, a thermal module, an inkjet module, a retransfer printing module, an input module, an output module, a label module, a topper module, a buffer module, a booklet leafing module, and a booklet closing module.

13. A modular material processing system interlock system, comprising a plurality of material processing function modules, wherein each function module comprises:
an access cover;
a power transmission device; and
a plurality of interlock switches configured such that opening a function module access cover operates predetermined interlock switches to disable the module power transmission device and deactivate hazard related circuits associated with the module and solely any adjacent function modules.

14. The modular material processing system interlock system according to claim 13, wherein the power transmission device is selected from the group consisting of a motor drive circuit device, a laser device, a hazardous light device, a pneumatic device, a hydraulic device, a voltage controller device, a current controller device, and an ultraviolet light device.

15. The modular material processing system interlock system according to claim 13, wherein the access cover is a hood.

16. The modular material processing system interlock system according to claim 13, wherein at least one interlock switch comprises an electromechanical switch.

17. The modular material processing system interlock system according to claim 13, wherein at least one interlock switch comprises a mechanical switch.

18. The modular material processing system interlock system according to claim 14, wherein the function modules comprise at least one module selected from the group consisting of a magnetic encoding module, an embossing module, a smart card module, a chip programming module, a laser printing module, a perforating module, a cleaning module, a laminating of personalized documents module, a thermal module, an inkjet module, a retransfer printing module, an input module, an output module, a label module, a topper module, a buffer module, a booklet leafing module, and a booklet closing module.

19. The modular material processing system interlock system according to claim 13, wherein each function module further comprises a manual bypass mechanism configured to selectively override the disablement of the module power transmission device and the deactivation of the motor circuits associated with the module and solely any adjacent function modules.
